(19) United States
(12) Patent Application Publication
(10) Pub. No.: US 2012/0292964 A1
(43) Pub. Date: Nov. 22, 2012

(54) ENCLOSED MOTORCYCLE CHILD SEAT

(76) Inventor: KEN HEIDT, Spring Hill, FL (US)

(21) Appl. No.: 13/452,672

(22) Filed: Apr. 20, 2012

Related U.S. Application Data
(60) Provisional application No. 61/477,240, filed on Apr. 20, 2011.

(51) Int. Cl. B60N 2/28

(52) U.S. Cl. 297/256.15

(57) ABSTRACT

An enclosed motorcycle child seat created to resemble the general shape of an enclosed helmet. The enclosed motorcycle child seat includes a base, which attaches to the back portion of the motorcycle seat. The base is attached to a hinged cover that opens and closes to receive a child. While seated, the cover closes over the child to completely engulf them inside the enclosed motorcycle child seat. By being adaptable to many different motorcycle makes and models, the enclosed motorcycle child seat offers greater functionality and transferability for both the diver and the child.

### CROSS REFERENCE TO OTHER APPLICATIONS

This application claims priority to U.S. Provisional Application Ser. No. 61/477,240 filed on Apr. 20, 2011.

### BACKGROUND OF THE INVENTION

1. Field of the Invention

The present invention relates to a child seat that mounts on the back of a motorcycle to permit a child or small passenger to safely ride on the motorcycle.

2. Description of Related Art

Motorcycle riding is a popular activity shared by a wide variety of individuals coming from an array of backgrounds. Because of the great popularity there are many public and government implemented rules and regulations that must be obeyed in order to ensure a safe riding experience. For example, many state governing bodies require that passengers on motorcycles must each have a dedicated seat and footrest. If these regulations are not followed the driver may experience serious penalties for noncompliance. Unfortunately, there are no direct safety measures implemented for cases when a child is a passenger rider except age limits and strongly discouraging young or child riders from riding in the first place. Riders are left to their best judgment of whether or not to take a child rider.

In recent years, motorcycle modifications and accessories have been developed to more easily carry a child rider. For example, U.S. Pat. No. 5,553,915 by Robert Stamatakis discloses an attachable passenger seat for two-wheeled vehicle wherein a seat is attached to a rear portion of a motorcycle seat to better enable a child to ride on the motorcycle. The seat includes side pads and a backrest to encase the back and sides of the passenger rider. Also the seat includes a seat belt to ensure that the remains seated while riding. While this seat does offer better protection for the child rider, small child or infant riders still cannot ride on the motorcycle.

It would be beneficial in the art to provide a motorcycle seat that allows small children or infants to ride on the motorcycle. It would also be desirable in the art to further provide a motorcycle seat that is enclosed for encapsulating protection to the inner child rider.

### SUMMARY OF THE INVENTION

The present invention relates to an enclosed motorcycle child seat comprising: a base, where said base mounts to a rear portion of a motorcycle seat; a cover attached to said base with a hinge, where said cover closes over said base to create a hollow cavity; a mounting unit connected to said base, where said mounting unit attaches said enclosed motorcycle child seat to a motorcycle; a plurality of mounting brackets attach to said base and said mounting unit, where said plurality of mounting brackets secure said enclosed motorcycle child seat upon said motorcycle seat; and a window attached to a front portion of said base, wherein said window allows a child seated within said hollow cavity to view out of said enclosed motorcycle child seat and wherein when said cover is over said base said enclosed motorcycle child seat resembled a helmet.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of an enclosed motorcycle child seat in accordance with an exemplary embodiment of the present invention.

### DETAILED DESCRIPTION OF THE DRAWINGS

The present invention relates to a child seat that mounts on the back of a motorcycle to permit a child or small passenger to safely ride on the motorcycle. The present invention provides an enclosed motorcycle child seat wherein the general shape of the seat resembles an enclosed helmet. The enclosed motorcycle child seat includes a base which attaches to the back portion of the motorcycle seat. The base is attached to a hinged cover that opens and closes to receive a child. While seated, the cover closes over the child to completely engulf them inside the enclosed motorcycle child seat. By being adaptable to many different motorcycle makes and models, the enclosed motorcycle child seat offers greater functionality and transferability for both the diver and the child.

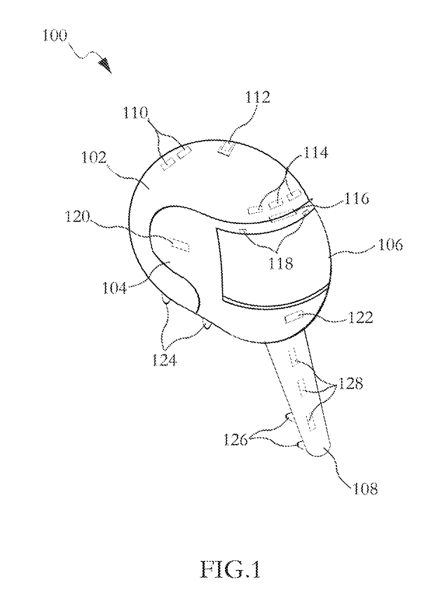

Turning now descriptively to the drawings, referring to FIG. 1, a perspective view of an enclosed motorcycle child seat (100) is shown in accordance with an exemplary embodiment of the present invention. The enclosed motorcycle child seat (100) may include a base (104) that attaches to a rear portion of a motorcycle seat. The base (104) includes a cover (102) that encases the top and rear portions of the enclosed motorcycle child seat (100). The enclosed motorcycle child seat (100) may have the general appearance of a helmet wherein the base (104) appears like the face portion of the helmet and the cover (102) resembles the outer casing. The base (104) and the cover (102) may include steel beams or tubing that comprises the outer rims of their structure for a strong and durable enclosure.

The cover (102) may fold against the base (104) at a hinge (116) attached to a front portion of the cover (102). A hollow cavity is created when the cover (102) is attached above the base (104). When the cover (102) is in place over the base (104) a lock attached to the cover (102) ensures that the cover (102) remains in place against the base (104) during use. The base (104) may include a safety belt or harness to secure a child placed upon the base (104).

Within the base (104) and the cover (102) may be a plurality of foam pads to ensure that if the enclosed motorcycle child seat (100) is hit or endures trauma that the child will remain safe beneath the cover (102). The base (104) may have a molded plastic seat that accepts the child in a seated position within the enclosed motorcycle child seat (100). The base (104) may be further modified to accept a baby seat wherein the adult rider may seat their infant on the base (104) and then close the cover (102) to create a safe and secure capsule around the baby.

The child seated within the enclosed motorcycle child seat (100) is able to easily breathe and talk to their parents or the driver through a plurality of vents (110, 114) situated on the cover (102). A pair of back air vents (110) maybe positioned against an upper back portion of the cover (102), while a row of front air vents is situated near where the hinge (116) attaches the cover (102) to the base (104). Additional air vents may be attached to the base (104) as well. A pair of side vents (120) positioned on each side of the base (104) and a lower air vent (122) positioned at a front lower portion of the base (104) may provide greater air circulation through the enclosed motorcycle child seat (100).

Additionally, a speaker system may be built into the cover (104) or the base (102) of the enclosed motorcycle child seat (100). The speaker system may allow the adult rider to have a microphone in their helmet which sends a sound feed into a set of speakers mounted within the cover (102). The cover (102) or the base (104) may have a microphone built within the walls that enable the child to speak to the driver while riding, therefore a two way communication system is provided within the enclosed motorcycle child seat (100).

On a front portion of the base (104) may be a window (106) that enables a child seated within the enclosed motorcycle child seat (100) to see out and the driver or parent to view the seated child. The window (106) may be secured to the base (104) with a pair of hinges (118) attached to along its top edge. The pair of hinges (118) enables the window (106) to lift and lower against the base (104). The window (106) may be made from a clear plastic and may include a tinted coating or a UV protective coating to protect the child from the bright light of the sun and UV rays.

Fastened below a front, lower portion of the base (104) may be a mounting unit (108) which extends from the base (104) down in front of the motorcycle seat. The mounting unit (108) braces the enclosed motorcycle child seat (100) against the motorcycle. The mounting unit (108) may be hollow to enable the child's legs and feet to rest within the mounting unit (108). A set of mounting unit vents (128) may be positioned along the length of the mounting unit (108) to allow air to pass into the mounting unit (108).

A plurality of mounting brackets (124, 126) may be attached to various positions on the enclosed motorcycle child seat (100). A set of seat mounting brackets (124) are attached below the sides of the base (104) to secure the base (104) against the motorcycle seat. Additionally, a set of front mounting brackets (126) are attached at a lower portion of the mounting unit (108) to provide additional support for the set of seat mounting brackets (124) thereby securely fastening the base (104) and mounting unit (108) to the motorcycle.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An enclosed motorcycle child seat comprising:
a base, where said base mounts to a rear portion of a motorcycle seat;
a cover attached to said base with a hinge, where said cover closes over said base to create a hollow cavity;
a mounting unit connected to said base, where said mounting unit attaches said enclosed motorcycle child seat to a motorcycle;
a plurality of mounting brackets attach to said base and said mounting unit, where said plurality of mounting brackets secure said enclosed motorcycle child seat upon said motorcycle seat; and
a window attached to a front portion of said base, wherein said window allows a child seated within said hollow cavity to view out of said enclosed motorcycle child seat and wherein when said cover is over said base said enclosed motorcycle child seat resembled a helmet.
